(19) United States
(12) Patent Application Publication
(10) Pub. No.: US 2016/0197353 A1
(43) Pub. Date: Jul. 7, 2016

(54) PERFORATED PLATE-SHAPED MATERIAL AND METHOD OF MANUFACTURING THE SAME

(71) Applicant: SHOYO SANGYO CO., LTD., Osaka-shi, Osaka (JP)

(72) Inventors: Takuji OSAKI, Osaka-shi, Osaka (JP); Nobuyuki SASAKI, Osaka-shi, Osaka (JP); Tomohisa KAWAKAMI, Osaka-shi, Osaka (JP); Aiko YABUKI, Osaka-shi, Osaka (JP); Junichi KUBOTA, Osaka-shi, Osaka (JP)

(73) Assignee: SHOYO SANGYO CO., LTD., Osaka-shi, Osaka (JP)

(21) Appl. No.: 14/911,735

(22) PCT Filed: Oct. 1, 2013
(86) PCT No.: PCT/JP2013/076648

§ 371 Date: Feb. 12, 2016

(30) Foreign Application Priority Data
Aug. 15, 2013 (JP) 2013-168945

(51) Int. Cl. H01M 4/74; H01G 11/84; H01G 11/70

(52) U.S. Cl. CPC H01M 4/742; H01G 11/70; H01G 11/84

(57) ABSTRACT

A perforated plate-shaped material in which a surface property/shape of a main surface of the plate-shaped material is maintained in at least a part of a hole surface forming a hole in the plate-shaped material are provided. The perforated plate-shaped material has at least one through hole penetrating from a first main surface to a second main surface opposite thereto, and in its cross-sectional shape, it has a smallest width portion on the hole surface and a first main surface portion where the hole surface terminates on the first main surface and includes a first projecting curve portion between the first main surface portion and the smallest width portion, and at least a part of the first projecting curve portion has a surface property/shape of a non-hole surface on the first main surface.

### TECHNICAL FIELD

The present invention relates to a perforated plate-shaped material and a method of manufacturing the same, and specifically to a perforated plate-shaped material suitably used for a collector of a power storage device exemplified by a capacitor such as a lithium ion capacitor and a secondary battery such as a lithium secondary battery and a method of manufacturing the same.

### BACKGROUND ART

For a secondary battery, efforts for preventing an electrode active material surface from peeling off or coming off and improving long-term performance by allowing connection of a binder applied to front and rear surfaces by using a metal collector having a through hole have conventionally been made. Efforts for exhibiting binding performance of a binder by setting a property/shape of a surface of an electrode to be coarse have also been made. Furthermore, a contrivance to form a coating film containing a carbon-based conductive substance on a surface of an electrode for lowering an internal resistance at the surface of the electrode and in an electrode active material layer and for improving adhesiveness with an electrode active material layer has also been made.

For a lithium ion secondary battery, an attempt to increase a capacity thereof has been made by forming a hole in a metal collector portion and filling also the hole portion with an electrode active material. Furthermore, for a lithium ion capacitor, an attempt to increase a capacity by maximizing capability of a negative electrode material through pre-doping in advance by allowing lithium ions to pass through an open metal collector has been made.

For example, Japanese Patent Laying-Open No. 2011-165637 (PTD 1) discloses a method of obtaining a positive electrode collector excellent in adhesiveness between the positive electrode collector and a positive electrode active material layer by forming a plurality of non-penetrating holes on a surface side of an electrode to thereby make the surface of the electrode coarse in order to suppress peeling off or coming off of the positive electrode active material layer from the positive electrode collector, for the purpose of enhancing durability in charge and discharge cycles of a positive electrode assembly for a lithium ion battery.

Japanese Patent Laying-Open No. 2010-212167 (PTD 2) discloses a method of suppressing peeling off of an electrode active material layer and a carbon coat layer for improving characteristics of a battery by forming the carbon coat layer high in surface roughness on a metal foil electrode.

Regarding a method of forming holes in a metal collector, Japanese Patent Laying-Open No. 11-067222 (PTD 3) discloses a method of increasing a battery capacity by forming holes by punching in a metal collector of a lithium ion battery so as to increase strength of an electrode and additionally by increasing an amount of an electrode active material for filling by allowing slurry of an electrode active material to sufficiently enter the holes.

Japanese Patent Laying-Open No. 2012-180583 (PTD 4) discloses a method of manufacturing a porous elongated metal foil small in thickness through chemical etching.

Japanese Patent Laying-Open No. 11-067217 (PTD 5) discloses a method of solving with physical means, an event of drop of slurry of an electrode active material from holes in application of the slurry, with the aid of a shape of holes formed through chemical etching.

Japanese Patent Laying-Open No. 2004-103462 (PTD 6) discloses a method of preventing an electrode active material from peeling off or coming off by allowing penetration through a metal foil member from both of a front surface and a rear surface and by allowing warpage or burr to remain.

### CITATION LIST

### Patent Document

PTD 1: Japanese Patent Laying-Open No. 2011-165637
PTD 2: Japanese Patent Laying-Open No. 2010-212167
PTD 3: Japanese Patent Laying-Open No. 11-067222
PTD 4: Japanese Patent Laying-Open No. 2012-180583
PTD 5: Japanese Patent Laying-Open No. 11-067217
PTD 6: Japanese Patent Laying-Open No. 2004-103462

### SUMMARY OF INVENTION

### Technical Problem

Even though non-penetrating small holes are formed in the surface of the metal foil collector as shown in Japanese Patent Laying-Open No. 2011-165637 (PTD 1) or even though the surface of the collector having a required property/shape is obtained by providing a carbon coat as shown in Japanese Patent Laying-Open No. 2010-212167 (PTD 2), there is no through hole and hence the hole cannot be filled with an electrode active material for increasing a capacity per volume, and pre-doping with lithium ions which will allow improvement in capacity of a negative electrode active material cannot efficiently be carried out in a lithium ion power storage device.

In addition, even though holes are formed in the metal foil collector by punching as shown in Japanese Patent Laying-Open No. 11-067222 (PTD 3) or even though holes are formed in the metal foil collector through chemical etching as shown in Japanese Patent Laying-Open No. 2012-180583 (PTD 4) or Japanese Patent Laying-Open No. 11-067217 (PTD 5), those hole portions are physically removed or chemically dissolved together with the surface of the metal foil collector. Therefore, properties of the inside of the metal foil collector rather than the surface thereof are directly exhibited at surfaces forming the holes, and hence properties of a main surface of the metal foil collector cannot be provided by hole surfaces which form the holes. Therefore, even though special properties and/or structures are added to the main surface of the metal foil collector in order to improve characteristics as a collector of a power storage device such as a capacitor or a secondary battery, such special properties and/or structures cannot be provided to the hole surfaces which form the holes.

Furthermore, though surface properties may be ensured in a part of holes with the method of forming holes with the use of a protruding object shown in Japanese Patent Laying-Open No. 2004-103462 (PTD 6), a large protruding object is formed in one main surface of the metal foil collector. Therefore, in a battery designed to include a thin electrode active material layer, the protruding object penetrates the electrode active material layer or a separator. Thus, this method cannot be used.

An object of the present invention is to solve the problems above and to provide, in connection with a plate-shaped material including a metal foil collector, a perforated plate-shaped material having a surface property/shape of a main surface of the plate-shaped material in at least a part of a hole surface forming a hole in the plate-shaped material and a method of manufacturing the same.

### Solution to Problem

According to one aspect, the present invention is directed to a perforated plate-shaped material having at least one through hole penetrating from a first main surface to a second main surface which is a main surface opposite to the first main surface. In a cross-sectional shape of the through hole in a plane perpendicularly intersecting, at a certain point on a contour of a perpendicularly projected image of the through hole onto the first main surface, with a tangent of the contour at the point, the perforated plate-shaped material has a smallest width portion on a hole surface providing an end portion of a smallest width representing a width of the perpendicularly projected image of the through hole onto the first main surface and a first main surface portion where the hole surface of the through hole terminates on the first main surface and includes a first projecting curve portion in a portion extending from the first main surface portion to the smallest width portion, and at least a part of the first projecting curve portion has a surface property/shape of a non-hole surface other than the hole surface on the first main surface.

In the cross-sectional shape of the through hole, the perforated plate-shaped material according to such an aspect of the present invention can further have a second main surface portion where the hole surface of the through hole terminates on the second main surface and can further include a second projecting curve portion in a portion extending from the smallest width portion to the second main surface portion.

In the perforated plate-shaped material according to such an aspect of the present invention, in the cross-sectional shape of the through hole, with a normal passing through the first main surface portion and being perpendicular to the first main surface being drawn, a first line segment length from a foot of a perpendicular line from the smallest width portion to the normal to the first main surface portion can be not less than 20% of a thickness of the perforated plate-shaped material. In the cross-sectional shape of the through hole, with a normal passing through the first main surface portion and being perpendicular to the first main surface being drawn, a second line segment length from a foot of a perpendicular line from the smallest width portion to the normal to a foot of a perpendicular line from the second main surface portion to the normal can be not more than 80% of a thickness of the perforated plate-shaped material. In the cross-sectional shape of the through hole, with a normal passing through the first main surface portion and being perpendicular to the first main surface being drawn, a third line segment length representing a length of a perpendicular line from the smallest width portion to the normal can be not less than 10% and not more than 500% of a thickness of the perforated plate-shaped material.

The perforated plate-shaped material according to such an aspect of the present invention can at least have a surface formed of a conductor and have a thickness not greater than 3 mm. In the perforated plate-shaped material according to such an aspect of the present invention, a diameter of a circle having an area equal to a hole area representing an area of the perpendicularly projected image of the through hole onto the first main surface can be not greater than 2 mm. In the perforated plate-shaped material according to such an aspect of the present invention, a height of a protruding object formed on at least any of the first main surface and the second main surface can be not more than 50% of a thickness of the perforated plate-shaped material and the perforated plate-shaped material can be a collector included in a power storage device.

According to another aspect, the present invention is directed to a method of manufacturing the perforated plate-shaped material according to the aspect above, which includes forming the through hole in a plate-shaped material by arranging the plate-shaped material on a die having a hole and an edge forming a circumference of the hole, applying a pressure to a region greater in size than the hole in the die in the plate-shaped material from at least one of a side of the plate-shaped material and a side of the die, and cutting the plate-shaped material at the edge of the die.

### Advantageous Effects of Invention

According to the present invention, in connection with a plate-shaped material including a metal foil collector, a perforated plate-shaped material having a surface property/shape of a main surface of the plate-shaped material in at least a part of a hole surface forming a hole in the plate-shaped material and a method of manufacturing the same can be provided.

### BRIEF DESCRIPTION OF DRAWINGS

FIG. 1 is a schematic cross-sectional view showing one example of a perforated plate-shaped material according to the present invention.

FIG. 2 is a schematic cross-sectional view showing another example of a perforated plate-shaped material according to the present invention.

FIG. 3 is a schematic cross-sectional view showing yet another example of a perforated plate-shaped material according to the present invention.

FIG. 4 is a schematic cross-sectional view showing yet another example of a perforated plate-shaped material according to the present invention.

FIG. 5 is a schematic cross-sectional view showing yet another example of a perforated plate-shaped material according to the present invention.

FIG. 6 is a schematic cross-sectional view showing one example of a method of manufacturing a perforated plate-shaped material according to the present invention.

FIG. 7 is a schematic cross-sectional view showing another example of a method of manufacturing a perforated plate-shaped material according to the present invention.

FIG. 8 shows a photograph showing a full view of a through hole in a first example of a perforated plate-shaped material according to the present invention.

FIG. 9 shows a photograph showing a part of the through hole in the first example of the perforated plate-shaped material according to the present invention.

FIG. 10 shows a photograph showing a cross-section of the part of the through hole in the first example of the perforated plate-shaped material according to the present invention.

FIG. 11 shows a photograph showing a full view of a through hole in a second example of a perforated plate-shaped material according to the present invention.

FIG. 12 shows a photograph showing a part of the through hole in the second example of the perforated plate-shaped material according to the present invention.

FIG. 13 shows a photograph showing a full view of a through hole in a third example of a perforated plate-shaped material according to the present invention.

FIG. 14 shows a photograph showing a part of the through hole in the third example of the perforated plate-shaped material according to the present invention.

FIG. 15 shows a photograph showing a cross-section of the part of the through hole in the third example of the perforated plate-shaped material according to the present invention.

FIG. 16 shows a photograph showing a full view of a through hole in a fourth example of a perforated plate-shaped material according to the present invention.

FIG. 17 shows a photograph showing a part of the through hole in the fourth example of the perforated plate-shaped material according to the present invention.

FIG. 18 shows a photograph showing a cross-section of the part of the through hole in the fourth example of the perforated plate-shaped material according to the present invention.

FIG. 19 shows a photograph showing a full view of a through hole in a fifth example of a perforated plate-shaped material according to the present invention.

FIG. 20 shows a photograph showing a part of the through hole in the fifth example of the perforated plate-shaped material according to the present invention.

FIG. 21 shows a photograph showing a full view of a through hole in a sixth example of a perforated plate-shaped material according to the present invention.

FIG. 22 shows a photograph showing a part of the through hole in the sixth example of the perforated plate-shaped material according to the present invention.

FIG. 23 shows a photograph showing a cross-section of the part of the through hole in the sixth example of the perforated plate-shaped material according to the present invention.

FIG. 24 shows a photograph showing a full view of a through hole in one example of a typical perforated plate-shaped material.

FIG. 25 shows a photograph showing a part of the through hole in one example of the typical perforated plate-shaped material.

FIG. 26 shows a photograph showing a cross-section of the part of the through hole in one example of the typical perforated plate-shaped material.

### DESCRIPTION OF EMBODIMENTS

### First Embodiment

### Perforated Plate-Shaped Material

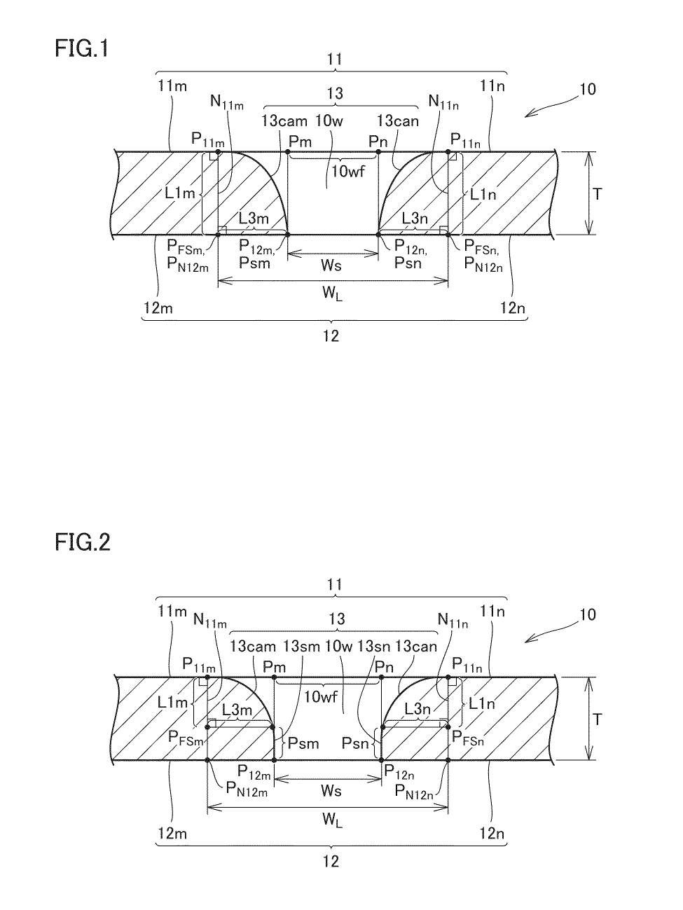

Referring to FIGS. 1 to 5, a perforated plate-shaped material 10 representing one embodiment of the present invention has at least one through hole 10w penetrating from a first main surface 11 to a second main surface 12 which is a main surface opposite to first main surface 11. In a cross-sectional shape of through hole 10w in a plane (this plane being referred to as a perpendicular plane; to be understood similarly hereafter) perpendicularly intersecting, at a certain point (this point corresponding, for example, to a point Pₘ which is a point on the contour of perpendicularly projected image 10wf in FIGS. 1 to 5; to be understood similarly hereafter) on a contour of a perpendicularly projected image 10wf of through hole 10w onto first main surface 11, with a tangent of the contour at that point, the perforated plate-shaped material has smallest width portions P_{Sm} and P_{Sn} on a hole surface 13 providing respective end portions Pₘ and Pₙ of a smallest width W_{S} representing a width of perpendicularly projected image 10wf of through hole 10w onto first main surface 11 and first main surface portions P₁₁ₘ and P₁₁ₙ where hole surface 13 of through hole 10w terminates on first main surface 11 and includes first projecting curve portions 13cam and 13can in respective portions extending from first main surface portions P₁₁ₘ and P₁₁ₙ to smallest width portions P_{Sm} and P_{Sn}, and at least a part of first projecting curve portions 13cam and 13can has a surface property/shape of non-hole surfaces 11m and 11n other than hole surface 13 on first main surface 11 (hereinafter also referred to as non-hole surfaces 11m and 11n on first main surface 11).

In the cross-sectional shape of through hole 10w, perforated plate-shaped material 10 in the present embodiment has smallest width portions P_{Sm} and P_{Sn} on hole surface 13 which provide respective end portions of smallest width W_{S} representing a width of perpendicularly projected image 10wf of through hole 10w onto first main surface 11 and first main surface portions P₁₁ₘ and P₁₁ₙ where hole surface 13 of through hole 10w terminates on first main surface 11 and includes first projecting curve portions 13cam and 13can in the respective portions extending from first main surface portions P₁₁ₘ and P₁₁ₙ to smallest width portions P_{Sm} and P_{Sn}.

The tangent of the contour at a certain point on the contour of perpendicularly projected image 10wf of through hole 10w onto first main surface 11 means a tangent, at a certain point of any points on a contour of perpendicularly projected image 10wf of through hole 10w onto first main surface 11, of that contour. In the cross-sectional shape of through hole 10w in the plane (perpendicular plane) perpendicularly intersecting, at that point, with the tangent of the contour at the point, a width of hole surface 13 forming through hole 10w is not constant but varied in a direction of thickness of perforated plate-shaped material 10 and has smallest width W_{S} and a largest width W_{L}. Here, smallest width W_{S} means a width of perpendicularly projected image 10wf of through hole 10w onto first main surface 11 on the perpendicular plane. End portions Pₘ and Pₙ of such smallest width W_{S} are provided by respective smallest width portions P_{Sm} and P_{Sn} on hole surface 13. End portions of largest width W_{L} are provided by respective first main surface portions P₁₁ₘ and P₁₁ₙ which are portions where hole surface 13 of through hole 10w reaches first main surface 11 and terminates.

First projecting curve portions 13cam and 13can are not restricted so long as they are upwardly projecting curves with respect to straight lines connecting first main surface portions P₁₁ₘ and P₁₁ₙ to respective smallest width portions P_{Sm} and P_{Sn}, and they may be curves in an elliptic arc shape or a parabolic shape. Here, curves include straight lines and also discontinuously varying lines. A curved surface formed by such a curve includes a plane and also a discontinuously varying surface.

First projecting curve portions 13cam and 13can have portions continuously varying in curvature in respective portions extending from first main surface portions P₁₁ₘ and P₁₁ₙ on first main surface 11 to smallest width portions P_{Sm} and P_{Sn} of through hole 10w. Therefore, in addition to a case that at least a part of first projecting curve portions 13cam and 13can of hole surface 13 included in the portions extending from first main surface portions P₁₁ₘ and P₁₁ₙ on first main surface 11 to respective smallest width portions P_{Sm} and P_{Sn} of through hole 10w has a surface property/shape of non-hole surfaces 11m and 11n (non-hole surfaces 11m and 11n other than the hole surface on first main surface 11) on first main surface 11 as it is, at least the part of first projecting curve portions can have a surface property/shape in a state that the surface property/shape is non-uniformly distributed like sea islands, in a state that the surface property/shape is one-dimensionally uniformly distributed in one arbitrarily specified direction, or in a state that the surface property/shape is two-dimensionally uniformly distributed in two arbitrarily specified directions. Therefore, perforated plate-shaped material 10 having, also in a part of hole surface 13, surface characteristics similar to those of non-hole surfaces 11m and 11n on first main surface 11 is obtained.

In perforated plate-shaped material 10 in the present embodiment, the surface property/shape of non-hole surfaces 11m and 11n on first main surface 11 includes an added surface property/shape (an added property, shape, and/or structure of a surface) in addition to an original surface property/shape of the plate-shaped material itself (an original property, shape, and/or structure of the surface). Here, examples of the added surface property/shape include (1) a surface shape of a striped or embossed shape unintentionally or intentionally formed through a rolling process, (2) a surface shape resulting from a property formed through a chemical, electric, or electrochemical treatment or process such as a chelation treatment or process, a discharging treatment or process, or formation of a conductive polymer film, (3) a surface shape resulting from a structure formed through film formation through application, plating, sputtering, chemical vapor deposition (CVD), adhesion, or vapor deposition, and (4) a surface shape resulting from a shape or a structure resulting from roughening of a surface through a blaster treatment, an electrolytic etching process, or a chemical etching process.

In such a perforated plate-shaped material 10, since the surface property/shape of the first main surface to which a special property, shape and/or structure added for improvement in characteristics of a power storage device such as a capacitor or a secondary battery has been added extends to at least a part of hole surface 13, the perforated plate-shaped material can suitably be used as a collector included in a power storage device.

Specifically, perforated plate-shaped material 10 is obtained, which has at least one function of a function to prevent an electrode active material layer from peeling off or coming off from first main surface 11 owing to strong bond of a binder included in slurry to a surface of first main surface 11 in forming the electrode active material layer by making the surface coarse by using a method of providing a plurality of small holes or recess portions in first main surface 11 and applying electrode active material slurry, a function to lower a contact resistance of first main surface 11 with the electrode active material layer by applying a substance low in electrical resistance to first main surface 11, a function to expand to a part of a hole surface of the through hole, a state that another specific property/shape or a surface skin provided to the surface of first main surface 11 is held as being intact, and a function to exhibit good wettability (slurry repellence prevention) of electrode active material slurry applied to first main surface 11, in accordance with a ratio of each function occupied in the hole.

Furthermore, perforated plate-shaped material 10 having through hole 10w, which has a function of a funnel shape, can be provided, the funnel shape preventing, in application of slurry of an electrode active material to one surface of perforated plate-shaped material 10, the slurry from passing through the through hole and dropping due to an opening width of the through hole on one main surface side smaller than an opening width on the other main surface side while allowing smooth introduction of the slurry in a homogenous state into holes such that voids remaining in the through hole are minimized during application of the slurry from the other main surface side for filling after application and drying of the slurry onto one main surface side.

(Cross-Sectional Shape of Through Hole)

Referring to FIGS. 1 to 5, in perforated plate-shaped material 10 in the present embodiment, the cross-sectional shape of through hole 10w means a shape of a cross-section of through hole 10w in the plane (perpendicular plane) perpendicularly intersecting, at a certain point on the contour of perpendicularly projected image 10wf of through hole 10w onto first main surface 11, with the tangent of the contour at that point. The cross-sectional shape has smallest width portions P_{Sm} and P_{Sn} and first main surface portions P₁₁ₘ and P₁₁ₙ and includes first projecting curve portions 13cam and 13can in the respective portions extending from first main surface portions P₁₁ₘ and P₁₁ₙ to smallest width portions P_{Sm} and P_{Sn}. The cross-sectional shape is not particularly restricted so long as at least a part of first projecting curve portions 13cam and 13can of hole surface 13 has a surface property/shape of non-hole surfaces 11m and 11n on first main surface 11, and includes, for example, cross-sectional shapes below. Since smallest width W_{S} represents a width of perpendicularly projected image 10wf of through hole 10w onto first main surface 11 on the perpendicular plane, smallest width portions P_{Sm} and P_{Sn} providing the respective end portions of smallest width W_{S} are not necessarily located at the same height position in the direction of thickness of perforated plate-shaped material 10.

Referring to FIG. 1, a first cross-sectional shape of through hole 10w is a shape including only first projecting curve portions 13cam and 13can in the respective portions on the perpendicular plane extending from first main surface portions P₁₁ₘ and P₁₁ₙ to smallest width portions P_{Sm} and P_{Sn}. In such a first cross-sectional shape, largest width W_{L} is obtained in first main surface portions P₁₁ₘ and P₁₁ₙ and smallest width portions P_{Sm} and P_{Sn} appear and smallest width W_{S} is obtained in second main surface portions P₁₂ₘ and P₁₂ₙ. Second main surface portions P₁₂ₘ and P₁₂ₙ refer to a portion where hole surface 13 of through hole 10w terminates on second main surface 12.

Referring to FIG. 2, a second cross-sectional shape of through hole 10w is a shape including first projecting curve portions 13cam and 13can and straight portions 13sm and 13sn which are straight lines perpendicular to first main surface 11, on the perpendicular plane. These straight portions 13sm and 13sn are formed in portions in the cross-section above which extend from terminal ends of first projecting curve portions 13cam and 13can to second main surface portions P₁₂ₘ and P₁₂ₙ, respectively. In such a second cross-sectional shape, largest width W_{L} is obtained in first main surface portions P₁₁ₘ and P₁₁ₙ and smallest width portions P_{Sm} and P_{Sn} appear and smallest width W_{S} is obtained between respective points of connection between first projecting curve portions 13cam and 13can and straight portions 13sm and 13sn and second main surface portions P₁₂ₘ and P₁₂ₙ.

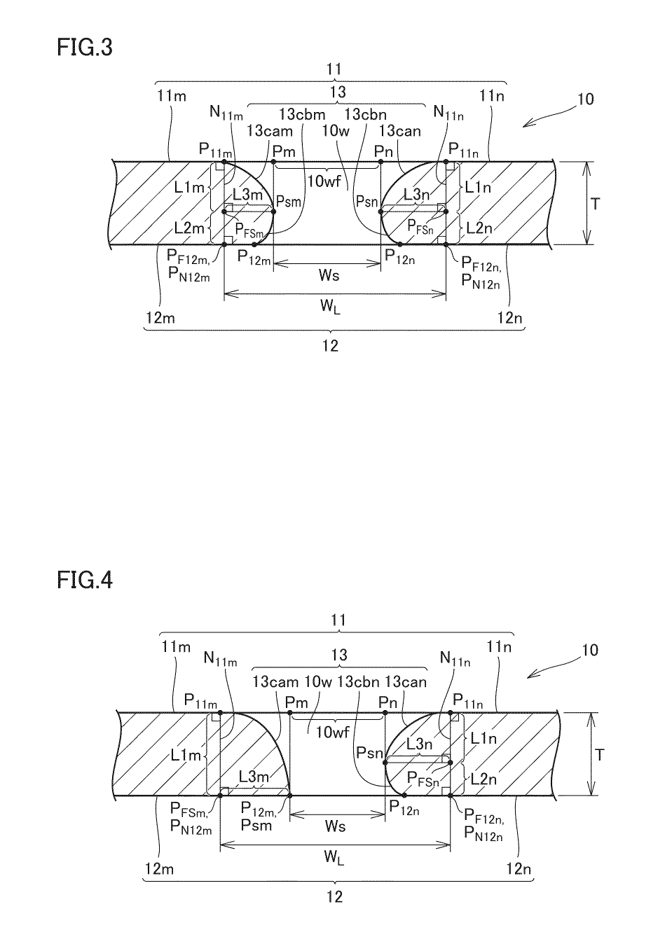

Referring to FIG. 3, a third cross-sectional shape of through hole 10w is a shape including first projecting curve portions 13cam and 13can and second projecting curve portions 13cbm and 13cbn on the perpendicular plane. These second projecting curve portions 13cbm and 13cbn are formed in portions of the cross-section above which extend from smallest width portions P_{Sm} and P_{Sn} of through hole 10w to second main surface portions P₁₂ₘ and P₁₂ₙ, respectively. In such a third cross-sectional shape, largest width W_{L} is obtained in first main surface portions P₁₁ₘ and P₁₁ₙ, smallest width portion P_{Sm} appears at a point of connection between first projecting curve portion 13cam and second projecting curve portion 13cbm, smallest width portion P_{Sn} appears at a point of connection between first projecting curve portion 13can and second projecting curve portion 13cbn, and smallest width W_{S} is provided by smallest width portions P_{Sm} and P_{Sn}. In such a third cross-sectional shape, largest width W_{L} is obtained in first main surface portions P₁₁ₘ and P₁₁ₙ and smallest width portions P_{Sm} and P_{Sn} giving smallest width W_{S} appear between first main surface portions P₁₁ₘ and P₁₁ₙ and second main surface portions P₁₂ₘ and P₁₂ₙ at positions the same or different in height in the direction of thickness of perforated plate-shaped material 10, depending on a difference in curvature between one first projecting curve portion 13cam and second projecting curve portion 13cbm and the other first projecting curve portion 13can and second projecting curve portion 13cbn.

Referring to FIG. 4, a fourth cross-sectional shape of through hole 10w is such a cross-sectional shape that one cross-sectional shape and the other cross-sectional shape in hole surface 13 forming through hole 10w are different from each other on the perpendicular plane, one cross-sectional shape being the first cross-sectional shape including only first projecting curve portion 13cam and the other cross-sectional shape being the third cross-sectional shape including first projecting curve portion 13can and second projecting curve portion 13cbn. In such a fourth cross-sectional shape, largest width W_{L} is obtained in first main surface portions P₁₁ₘ and P₁₁ₙ, and smallest width portions P_{Sm} and P_{Sn} giving smallest width W_{S} appear at positions different in height in the direction of thickness of perforated plate-shaped material 10, in which smallest width portion P_{Sm} on the side of the first cross-sectional shape appears in second main surface portion P₁₂ₘ and smallest width portion P_{Sn} on the side of the third cross-sectional shape appears at the point of connection between first projecting curve portion 13can and second projecting curve portion 13cbn.

Referring to FIG. 5, a fifth cross-sectional shape of through hole 10w is such a cross-sectional shape that one cross-sectional shape and the other cross-sectional shape in hole surface 13 forming through hole 10w are different from each other on the perpendicular plane, one cross-sectional shape being the second cross-sectional shape including first projecting curve portion 13cam and straight portion 13sm and the other cross-sectional shape being the third cross-sectional shape including first projecting curve portion 13can and second projecting curve portion 13cbn. In such a fifth cross-sectional shape, largest width W_{L} is obtained in first main surface portions P₁₁ₘ and P₁₁ₙ, and smallest width portions P_{Sm} and P_{Sn} giving smallest width W_{S} appear at positions the same or different in height in the direction of thickness of perforated plate-shaped material 10, in which smallest width portion P_{Sm} on the side of the second cross-sectional shape appears between the point of connection between first projecting curve portion 13cam and straight portion 13sm and second main surface portions P₁₂ₘ and P₁₂ₙ and smallest width portion P_{Sn} on the side of the third cross-sectional shape appears at the point of connection between first projecting curve portion 13can and second projecting curve portion 13cbn.

In perforated plate-shaped material 10 in the present embodiment, whether hole surface 13 of through hole 10w has a cross-sectional shape of any of the first to fifth cross-sectional shapes or another cross-sectional shape which is not shown here is different, depending on a physical property and a thickness of perforated plate-shaped material 10 as well as magnitude of a pressure applied in formation of a through hole in a plate-shaped material and a way of application of the pressure.

Perforated plate-shaped material 10 expressed with at least any of the first to fifth cross-sectional shapes has first projecting curve portions 13cam and 13can having portions continuously varying in curvature in the respective portions extending from first main surface portions P₁₁ₘ and P₁₁ₙ on first main surface 11 to smallest width portions P_{Sm} and P_{Sn} of through hole 10w. Therefore, in addition to a case that at least a part of first projecting curve portions 13cam and 13can of hole surface 13 included in the respective portions extending from first main surface portions P₁₁ₘ and P₁₁ₙ to smallest width portions P_{Sm} and P_{Sn} of through hole 10w has a surface property/shape of non-hole surfaces 11m and 11n on first maim surface 11 as it is, at least the part of first projecting curve portions can have a surface property/shape in a state that the surface property/shape is non-uniformly distributed like sea islands, in a state that the surface property/shape is one-dimensionally uniformly distributed in one arbitrarily specified direction, or in a state that the surface property/shape is two-dimensionally uniformly distributed in two arbitrarily specified directions.

Referring to FIGS. 1 to 5, in perforated plate-shaped material 10 in the present embodiment, though not particularly restricted, in the cross-sectional shape of through hole 10w in the plane (perpendicular plane) perpendicularly intersecting, at a certain point on the contour of perpendicularly projected image 10wf of through hole 10w onto first main surface 11, with the tangent of the contour at that point, with normals N₁₁ₘ and N₁₁ₙ passing through first main surface portions P₁₁ₘ and P₁₁ₙ and being perpendicular to first main surface 11 being drawn, respective first line segment lengths L1m and L1n from feet P_{FSm} and P_{FSn} of perpendicular lines from smallest width portions P_{Sm} and P_{Sn} (each defined as a point closest to first main surface 11 when smallest width portions P_{Sm} and P_{Sn} have a length) to normals N₁₁ₘ and N₁₁ₙ to first main surface portions P₁₁ₘ and P₁₁ₙ are preferably not less than 20%, more preferably not less than 40%, and further preferably not less than 60% of a thickness T of perforated plate-shaped material 10 from a point of view of greater first projecting curve portions 13cam and 13can including the portion having the surface property/shape of non-hole surfaces 11m and 11n on first main surface 11.

Here, thickness T of perforated plate-shaped material 10 is defined as a distance from any point on the first main surface portion through that point to a point where a normal perpendicular to first main surface 11 reaches second main surface 12. For example, in the cross-sectional shape of through hole 10w shown in FIGS. 1 to 5, thickness T of perforated plate-shaped material 10 is defined as a distance from first main surface portion P₁₁ₘ through first main surface portion P₁₁ₘ to a point P_{N12m} where normal N₁₁ₘ perpendicular to first main surface 11 reaches second main surface 12. Though distribution of thicknesses T at any point on the first main surface portion of perforated plate-shaped material 10 is not particularly restricted, from a point of view of providing stable physical properties, a ratio Tₘₐₓ/Tₘᵢₙ of a maximal thickness Tₘₐₓ to a minimal thickness Tₘᵢₙ is preferably not smaller than 1.00 and not greater than 1.15.

In perforated plate-shaped material 10 in the present embodiment, though not particularly restricted, in the cross-sectional shape of through hole 10w in the plane (perpendicular plane) perpendicularly intersecting, at a certain point on the contour of perpendicularly projected image 10wf of through hole 10w onto first main surface 11, with the tangent of the contour at that point, with normals N₁₁ₘ and N₁₁ₙ passing through first main surface portions P₁₁ₘ and P₁₁ₙ and being perpendicular to first main surface 11 being drawn, though respective third line segment lengths L3m and L3n representing lengths of perpendicular lines from smallest width portions P_{Sm} and P_{Sn} (each defined as a point closest to first main surface 11 when smallest width portions P_{Sm} and P_{Sn} have a length) to normals N₁₁ₘ and N₁₁ₙ are not particularly restricted, from a point of view of improving a factor of filling with an electrode active material by raising a ratio of a portion of a hole surface opening like a funnel, the third line segment length is preferably not less than 10%, more preferably not less than 30%, and further preferably not less than 50% of thickness T of perforated plate-shaped material 10. From a point of view of preventing decrease in thickness T due to overlap of a region having largest width W_{L} with an adjacent hole when a ratio of opening is high, the third line segment length is preferably not more than 500%, more preferably not more than 300%, and further preferably not more than 200% of thickness T of perforated plate-shaped material 10. Here, definition of thickness T of perforated plate-shaped material 10 and distribution of thicknesses T at any point on the first main surface portion of perforated plate-shaped material 10 are as described above.

Referring to FIGS. 3 to 5, though not particularly restricted, from a point of view of ability to form a smallest width portion smaller than a diameter of a hole in a die when a hole having a smaller diameter is required in application of electrode active material slurry, in the cross-sectional shape of through hole 10w in the plane (perpendicular plane) perpendicularly intersecting, at a certain point on the contour of perpendicularly projected image 10wf of through hole 10w onto first main surface 11, with the tangent of the contour at that point, perforated plate-shaped material 10 in the present embodiment preferably further has second main surface portions P₁₂ₘ and P₁₂ₙ where hole surface 13 of through hole 10w terminates on second main surface 12 and further includes second projecting curve portions 13cbm and 13cbn in respective portions extending from smallest width portions P_{Sm} and P_{Sn} to second main surface portions P₁₂ₘ and P₁₂ₙ. Second main surface portions P₁₂ₘ and P₁₂ₙ refer to a portion where hole surface 13 of through hole 10w terminates on second main surface 12 and includes a case that that portion is pointed and an inclination of the tangent abruptly changes before and after that portion and a case that the portion is not pointed and an inclination of the tangent gradually changes before and after that portion.

In perforated plate-shaped material 10 in the present embodiment, in the cross-sectional shape of through hole 10w in the plane (perpendicular plane) perpendicularly intersecting, at a certain point on the contour of perpendicularly projected image 10wf of through hole 10w onto first main surface 11, with the tangent of the contour at that point, with normals N₁₁ₘ and N₁₁ₙ passing through first main surface portions P₁₁ₘ and P₁₁ₙ and being perpendicular to first main surface 11 being drawn, though respective second line segment lengths L2m and L2n from feet P_{FSm} and P_{FSn} of perpendicular lines from smallest width portions P_{Sm} and P_{Sn} (each defined as a point closest to first main surface 11 when smallest width portions P_{Sm} and P_{Sn} have a length) to normals N₁₁ₘ and N₁₁ₙ to feet P_{F12m} and P_{F12n} of perpendicular lines from second main surface portions P₁₂ₘ and P₁₂ₙ to normals N₁₁ₘ and N₁₁ₙ are not particularly restricted, from a point of view of higher expression of an effect provided by the surface property/shape of non-hole surfaces 11m and 11n on first main surface 11 in the through hole owing to presence of more first projecting curve portions including that surface property/shape, the second line segment length is preferably not more than 80%, more preferably not more than 60%, and further preferably not more than 40% of thickness T of perforated plate-shaped material 10. Here, definition of thickness T of perforated plate-shaped material 10 and distribution of thicknesses T at any point on the first main surface portion of perforated plate-shaped material 10 are as described above.

(Two-Dimensional Shape of Through Hole)

Referring to FIGS. 1 to 5, a two-dimensional shape (referring to a shape of perpendicularly projected image 10wf of through hole 10w onto first main surface 11; to be understood similarly hereafter) of through hole 10w in perforated plate-shaped material 10 in the present embodiment is not particularly restricted so long as it is formed as a closed curve, and may be any of annular, oval, polygonal, or indefinite in shape.

(Two-Dimensional Size of Through Hole)

Referring to FIGS. 1 to 5, a two-dimensional size (referring to a size of perpendicularly projected image 10wf of through hole 10w onto first main surface 11) of through hole 10w of perforated plate-shaped material 10 in the present embodiment is not particularly restricted. From a point of view of processability at low cost and enhancement in performance to hold electrode active material slurry, however, a diameter of a circle having an area equal to a hole area (referring to an area of perpendicularly projected image 10wf of through hole 10w onto first main surface 11; to be understood similarly hereafter) of through hole 10w is preferably not smaller than 20 μm and not greater than 2 mm, more preferably not smaller than 40 μm and not greater than 500 μm, and further preferably not smaller than 60 μm and not greater than 300 μm.

(Ratio of Opening of Perforated Plate-Shaped Material)

Referring to FIGS. 1 to 5, a ratio of opening of perforated plate-shaped material 10 in the present embodiment is not particularly restricted. From a point of view of effectively using a surface property/shape of the perforated plate-shaped material in terms of an area or enhancing efficiency in making use of pre-doping with lithium ions which allows improvement in capacity of a negative electrode active material in a lithium ion power storage device and further ensuring mechanical strength of plate-shaped material 10, however, the ratio of opening is preferably not lower than 1% and not higher than 70%, more preferably not lower than 5% and not higher than 50%, and further preferably not lower than 8% and not higher than 35%.

(Thickness of Perforated Plate-Shaped Material)

Referring to FIGS. 1 to 5, thickness T of perforated plate-shaped material 10 in the present embodiment is not particularly restricted. From a point of view of enhancing handleability in fabrication of a power storage device and increasing a capacity per volume and/or per mass of the power storage device, however, the thickness is preferably not smaller than 1 μm and not greater than 3 mm, more preferably not smaller than 3 μm and not greater than 100 μm, and further preferably not smaller than 5 μm and not greater than 50 μm.

(Material for Perforated Plate-Shaped Material)

Referring to FIGS. 1 to 5, though not particularly restricted, perforated plate-shaped material 10 in the present embodiment preferably has at least a surface formed of a conductor, from a point of view of use as a collector of a power storage device. Namely, perforated plate-shaped material 10 in the present embodiment may be a material of which surface and inside as a whole are formed of a conductor or a material of which surface alone is formed of a conductor. Here, though the conductor is not particularly restricted, from a point of view of high conductivity and ease in shaping into a plate and in forming a hole, copper, a copper alloy, aluminum, an aluminum alloy, stainless steel, silver, and gold are preferred.

(Flatness of Main Surface of Perforated Plate-Shaped Material)

Referring to FIGS. 1 to 5, perforated plate-shaped material 10 in the present embodiment preferably has no portion protruding outward, such as large warpage or burr which has intentionally been added for prevention of peeling off or coming off. From a point of view of avoiding the possibility of penetration through a thin electrode active material layer, a height of a protruding object formed on at least any of first main surface 11 and second main surface 12 is preferably not higher than 50% and more preferably not higher than 25% of thickness T of plate-shaped material 10.

### Second Embodiment

### Method of Manufacturing Perforated Plate-Shaped Material

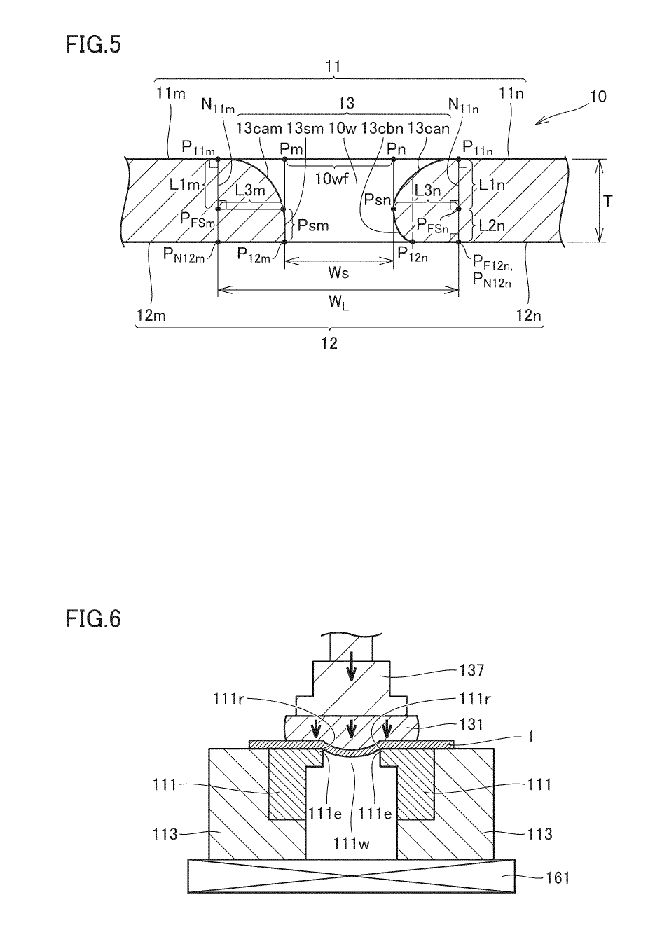

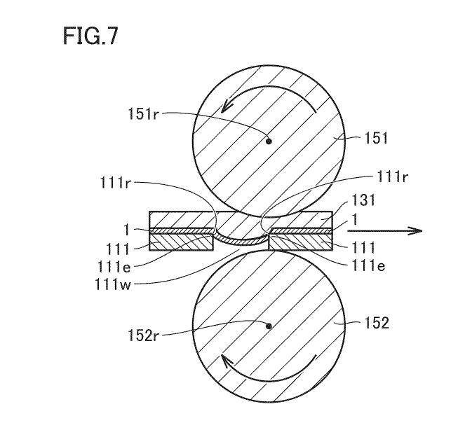

Referring to FIGS. 6 and 7, a method of manufacturing perforated plate-shaped material 10 representing another embodiment of the present invention is a method of manufacturing perforated plate-shaped material 10 in the first embodiment, in which through hole 10w is formed in a plate-shaped material 1 by arranging plate-shaped material 1 on a die 111 having a hole 111w and an edge 111e forming a circumference 111r of hole 111w such that a second main surface side is in contact with die 111, applying a pressure to a region greater in size than hole 111w in die 111 in plate-shaped material 1 from at least one of a side of plate-shaped material 1 and a side of die 111, and cutting plate-shaped material 1 at edge 111e of die 111.

According to the method of manufacturing perforated plate-shaped material 10 in the present embodiment, perforated plate-shaped material 10 can be manufactured at low cost and at high efficiency by forming through hole 10w corresponding in shape and size to hole 111w in die 111 in the plate-shaped material by arranging plate-shaped material 1 on die 111, simultaneously or successively applying a pressure to a region greater in size than hole 111w in die 111 in plate-shaped material 1 from at least one of the side of plate-shaped material 1 and the side of die 111, and cutting plate-shaped material 1 along edge 111e of die 111.

In the method of manufacturing perforated plate-shaped material 10 in the present embodiment, plate-shaped material 1 deforms as a result of application of a pressure to the region greater in size than hole 111w in die 111 in plate-shaped material 1 from at least one of the side of plate-shaped material 1 and the side of die 111. Plate-shaped material 1 is then cut by being pushed with stress concentrated on a portion of edge 111e of die 111. Perforated plate-shaped material 10 is thus obtained.

Therefore, referring to FIGS. 1 to 7, in obtained perforated plate-shaped material 10, a shape and a size of through hole 10w in second main surface portions P₁₂ₘ and P₁₂ₙ of second main surface 12 in contact with die 111 are substantially the same as a shape and a size of hole 111w in die 111. Smallest width W_{S} at smallest width portions P_{Sm} and P_{Sn} of through hole 10w is not smaller than a result calculated by subtracting a thickness of the plate-shaped material from a width of through hole 10w in second main surface portions P₁₂ₘ and P₁₂ₙ and smaller than largest width W_{L} of through hole 10w in first main surface portions P₁₁ₘ and P₁₁ₙ.

In the method of manufacturing perforated plate-shaped material 10 in the present embodiment, how to apply a pressure to a region greater in size than hole 111w in die 111 in plate-shaped material 1 is not particularly restricted. For example, as shown in FIG. 6, a pressure can be applied by bringing a first solid object 131 which can deform as a result of application of a pressure into contact with the region of plate-shaped material 1. Alternatively, as shown in FIG. 7, a pressure can be applied by bringing first solid object 131 which can deform as a result of application of a pressure into contact with the region of plate-shaped material 1, further brining a first rotatable auxiliary solid object 151 into contact with first solid object 131, further bringing a second rotatable auxiliary solid object 152 into contact with die 111, and moving first auxiliary solid object 151 and second auxiliary solid object 152 relative to plate-shaped material 1 while rotating the first auxiliary solid object and the second auxiliary solid object. Deformable first solid object 131 can further be implemented by a deformable solid object in a plurality of layers or in a block or an object resulting from addition of an undeformable solid object to this solid object. Such a manufacturing method will specifically be described below.

Referring to FIG. 6, in one example of the method of manufacturing perforated plate-shaped material 10 in the present embodiment, through hole 10w having a shape and a size (for example, an area) corresponding to a shape and a size (for example, an area) of hole 111w in die 111 is formed in plate-shaped material 1 by arranging plate-shaped material 1 on die 111 having hole 111w and edge 111e forming circumference 111r of hole 111w, bringing first solid object 131 which can be deformed by a pressure into contact with a region greater in size (for example, area) than hole 111w in die 111 in plate-shaped material 1 to thereby simultaneously apply a pressure from at least one of the side of plate-shaped material 1 and the side of die 111, and cutting plate-shaped material 1 along edge 111e of die 111.

Specifically, referring to FIG. 6, plate-shaped material 1 is arranged on die 111 having hole 111w and edge 111e forming circumference 111r of hole 111w. First solid object 131 which can deform as a result of application of a pressure is arranged on the region greater in size than hole 111w in die 111 of plate-shaped material 1. A pressurization press 137 is arranged on first solid object 131.

A pressure is then applied to first solid object 131 by using pressurization press 137. First solid object 131 to which a pressure is applied comes in contact with the region greater in size than hole 111w in die 111 in plate-shaped material 1, so that a pressure is applied to that region. Under such a pressure, a portion of first solid object 131 located above hole 111w in die 111 deforms as projecting toward die 111. Therefore, the portion of plate-shaped material 1 located over hole 111w in die 111 is pushed into hole 111w. Therefore, since a portion of plate-shaped material 1 in contact with edge 111e forming circumference 111r of hole 111w of die 111 is pressed against edge 111e, the plate-shaped material is cut along edge 111e.

Here, first solid object 131 is not particularly restricted so long as it is a solid object which can deform as a result of application of a pressure, and it may be of any type of a material including a metal, ceramics, glass, a resin, and rubber. A hole is formed in the plate-shaped material normally at a temperature not lower than −20° C. and not higher than 200° C. even in consideration of a type of a material for the plate-shaped material, and hence a solid object which can deform as a result of application of a pressure in such a temperature range is preferred.

Here, though a material for die 111 is not particularly restricted, from a point of view of formation of through hole 10w in plate-shaped material 1, alloy tool steel or cemented carbide is suitable. Though a material for a die holder 113 is not particularly restricted, from a point of view of high mechanical strength and durability, carbon steel for mechanical structure is suitable. Circumference 111r of hole 111w in die 111 should only be defined by any closed curve, and any shape including an annular shape, an oval shape, a polygonal shape, and an indefinite shape is acceptable. From a point of view of processability at low cost and of performance to hold electrode active material slurry, a diameter of a circle equal in area to a hole in die 111 is preferably not smaller than 20 μm and not greater than 2 mm, more preferably not smaller than 40 μm and not greater than 500 μm, and further preferably not smaller than 60 μm and not greater than 300 μm.

FIG. 6 shows a case that plate-shaped material 1 is arranged on die 111 having hole 111w, first solid object 131 is arranged on plate-shaped material 1, pressurization press 137 is arranged on first solid object 131, and a pressure is applied from the side of plate-shaped material 1 with the side of die 111 being fixed. Though not shown, a die having a hole can be arranged on a pressurization press, a plate-shaped material can be arranged on the die having the hole, a first solid object can be arranged on the plate-shaped material, and a pressure can be applied from a side of the die having the hole with a side of the plate-shaped material being fixed. Alternatively, a die having a hole can be arranged on a pressurization press, a plate-shaped material can be arranged on the die having the hole, a first solid object can be arranged on the plate-shaped material, a pressurization press can be arranged on the first solid object, and a pressure can be applied from both of a side of the die having the hole and a side of the plate-shaped material.

Referring to FIG. 7, in another example of the method of manufacturing perforated plate-shaped material 10 in the present embodiment, through hole 10w having a shape and a size (for example, an area) corresponding to a shape and a size (for example, an area) of hole 111w in die 111 is formed in plate-shaped material 1 by arranging plate-shaped material 1 on die 11 having hole 111w and edge 111e forming circumference 111r of hole 111w, successively applying a pressure from at least one of the side of plate-shaped material 1 and the side of die 111 by bringing first solid object 131 which can be deformed by a pressure into contact with the region greater in size (for example, area) than hole 111w in die 111 in plate-shaped material 1, further bringing first rotatable auxiliary solid object 151 into contact with first solid object 131, further bringing second rotatable auxiliary solid object 152 into contact with die 111, and applying a pressure to plate-shaped material 1 between first solid object 131 and die 111 with first solid object 131 and die 111 being interposed between first auxiliary solid object 151 and second auxiliary solid object 152 while moving first auxiliary solid object 151 and second auxiliary solid object 152 relative to plate-shaped material 1 with first auxiliary solid object 151 and second auxiliary solid object 152 being rotated around respective axes of rotations 151r and 152r, and cutting plate-shaped material 1 along edge 111e of die 111.

Here, first auxiliary solid object 151 and second auxiliary solid object 152 which are rotatable are not particularly restricted so long as they can rotate and relatively move. From a point of view of ease in rotation and relative movement, however, the first auxiliary solid object and the second auxiliary solid object are preferably implemented by rolls.

A method of moving first auxiliary solid object 151 and second auxiliary solid object 152 relative to plate-shaped material 1 while rotating first auxiliary solid object 151 and second auxiliary solid object 152 is not particularly restricted. First auxiliary solid object 151 and second auxiliary solid object 152 may be moved with respect to a stack of die 111, plate-shaped material 1, and first solid object 131, or the stack of die 111, plate-shaped material 1, and first solid object 131 may be moved with respect to first auxiliary solid object 151 and second auxiliary solid object 152. Namely, it is sufficient to move first auxiliary solid object 151 and second auxiliary solid object 152 relative to plate-shaped material 1 while rotating first auxiliary solid object 151 and second auxiliary solid object 152 by moving at least one of the stack of die 111, plate-shaped material 1, and first solid object 131, first auxiliary solid object 151, and second auxiliary solid object 152. First auxiliary solid object 151 and second auxiliary solid object 152 may be the same or different in period of rotation.

Perforated plate-shaped material 10 in the first embodiment obtained with the manufacturing method as above has, in the cross-sectional shape of through hole 10w in the plane (perpendicular plane) perpendicularly intersecting, at a certain point on the contour of perpendicularly projected image 10wf of through hole 10w onto first main surface 11, with the tangent of the contour at that point, smallest width portions P_{Sm} and P_{Sn} on hole surface 13 providing respective end portions Pₘ and Pₙ of smallest width W_{S} representing a width of perpendicularly projected image 10wf of through hole 10w onto first main surface 11 and first main surface portions P₁₁ₘ and P₁₁ₙ where hole surface 13 of through hole 10w terminates on first main surface 11 and includes first projecting curve portions 13cam and 13can in respective portions extending from first main surface portions P₁₁ₘ and P₁₁ₙ to smallest width portions P_{Sm} and P_{Sn}, at least a part of first projecting curve portions P₁₁ₘ and P₁₁ₙ has a surface property/shape of non-hole surfaces 11m and 11n other than hole surface 13 on first main surface 11 (non-hole surfaces 11m and 11n on first main surface 11), the surface property/shape of non-hole surfaces 11m and 11n on first main surface 11 to which a special property, shape, and/or structure added for improvement in characteristics of a power storage device such as a secondary battery and a capacitor has been added extends to at least a part of hole surface 13, and there is substantially no burr which forms a protruding object also on first main surface 11 and second main surface 12. Therefore, the perforated plate-shaped material can suitably be used as a collector included in a power storage device.

### EXAMPLES

### Example 1

Referring to FIG. 7, an aluminum foil for collector (1N30-H18 manufactured by Toyo Aluminium K.K.) having a thickness of 20 μm and having striped projections and recesses formed as a result of pressurization onto a first main surface was arranged as plate-shaped material 1 on die 111 which was made of stainless steel and had hole 111w having a diameter of 200 μm, such that a side of a second main surface was in contact with die 111. A synthetic resin board having a thickness of 0.3 mm which was deformable as a result of pressurization was arranged as first solid object 131 on the first main surface which was the main surface opposite to the second main surface of plate-shaped material 1. A roll having a diameter of 200 mm and serving as first auxiliary solid object 151 was brought in contact with first solid object 131, a roll having a diameter of 200 mm and serving as second auxiliary solid object 152 was brought in contact with die 111, and first auxiliary solid object 151 and second auxiliary solid object 152 were arranged such that the stack of first solid object 131, plate-shaped material 1, and die 111 lay between first auxiliary solid object 151 and second auxiliary solid object 152.

Then, a pressure was applied to first solid object 131, plate-shaped material 1, and die 111 by rotating first auxiliary solid object 151 and second auxiliary solid object 152 while a line pressure of 4 kN/cm was applied thereto, so that the pressure was applied to a region greater in size than hole 111w in die 111 in plate-shaped material 1 with first solid object 131 being interposed and a through hole was formed in plate-shaped material 1. Thus, the perforated plate-shaped material was obtained.

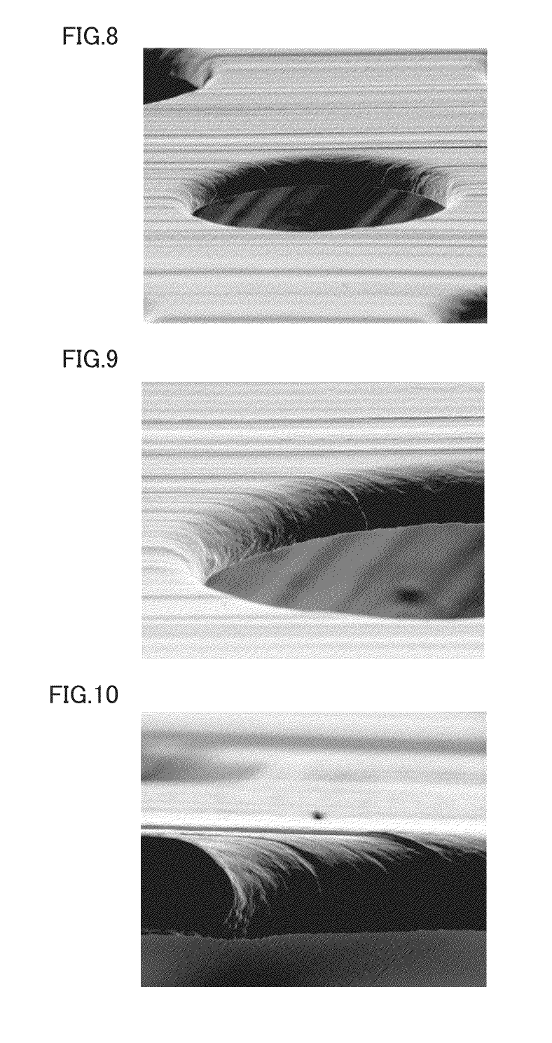

FIG. 8 shows a photograph of a full view of the through hole in the obtained perforated plate-shaped material, FIG. 9 shows a photograph of a part thereof, and FIG. 10 shows a photograph of a cross-section of the part. The through hole in the obtained perforated plate-shaped material had a largest width diameter of 232 μm in the first main surface portion and a smallest width diameter of 195 μm in the smallest width portion.

Referring to FIGS. 8 and 9, in the obtained perforated plate-shaped material, the striped projections and recesses formed in the non-hole surface on the first main surface were also observed on the hole surface. Namely, at least a part of the first projecting curve portion on the hole surface had the surface property/shape of the non-hole surface on the first main surface. Substantially no burr was observed.

Referring to FIG. 10, in the cross-section of the part of the through hole in the perforated plate-shaped material, the hole surface forming the through hole had the third cross-sectional shape including the first projecting curve portion in the portion extending from the first main surface portion on the first main surface to the smallest width portion of the through hole and further including the second projecting curve portion in the portion extending from the smallest width portion of the through hole to the second main surface portion on the second main surface. Here, with the normal passing through the first main surface portion and being perpendicular to the first main surface being drawn, the first line segment length from the foot of the perpendicular line from the smallest width portion to the normal to the first main surface portion (hereinafter simply referred to as the first line segment length) was 70% of the thickness of the perforated plate-shaped material. With the normal passing through the first main surface portion and being perpendicular to the first main surface being drawn, the second line segment length from the foot of the perpendicular line from the smallest width portion to the normal to the foot of the perpendicular line from the second main surface portion to the normal (hereinafter simply referred to as the second line segment length) was 30% of the thickness of the perforated plate-shaped material. With the normal passing through the first main surface portion and being perpendicular to the first main surface being drawn, the third line segment length representing the length of the perpendicular line from the smallest width portion to the normal (hereinafter simply referred to as the third line segment length) was 80% of the thickness of the perforated plate-shaped material.

### Example 2

The perforated plate-shaped material was obtained as in Example 1 except for use as the plate-shaped material, of an aluminum foil for collector (20C054 manufactured by Japan Capacitor Industrial Co., Ltd.) having a thickness of 20 μm and having projections and recesses formed in the first main surface through electrolytic etching.

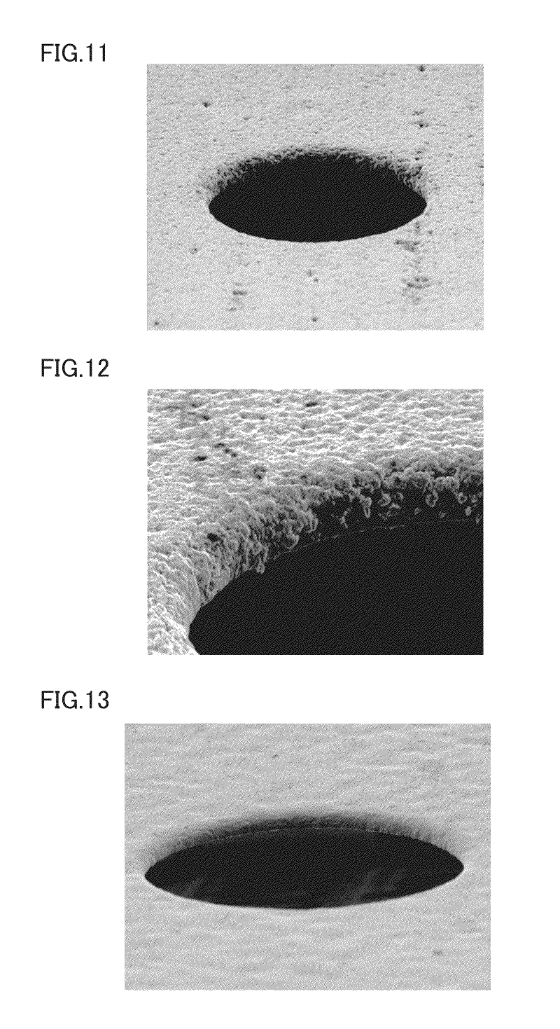

FIG. 11 shows a photograph of a full view of a through hole in the obtained perforated plate-shaped material and FIG. 12 shows a photograph of a part thereof. The through hole in the obtained perforated plate-shaped material had a largest width diameter of 212 μm in the first main surface portion and a smallest width diameter of 192 μm in the smallest width portion.

Referring to FIGS. 11 and 12, in the obtained perforated plate-shaped material, the projections and recesses formed in the non-hole surface on the first main surface were also observed on the hole surface. Namely, at least a part of the first projecting curve portion on the hole surface had the surface property/shape of the non-hole surface on the first main surface. Substantially no burr was observed.

### Example 3

The perforated plate-shaped material was obtained as in Example 1 except for use as the plate-shaped material, of a copper foil for collector (NC-WS manufactured by Furukawa Denki Co., Ltd.) having a thickness of 10 μm and having embossed projections and recesses formed in the first main surface through an electrolytic method.

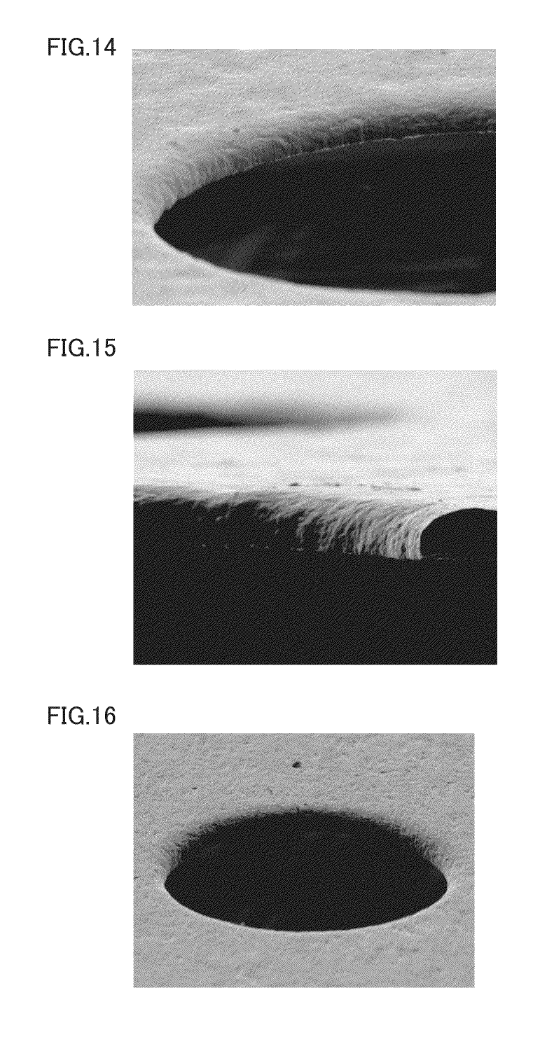

FIG. 13 shows a photograph of a full view of a through hole in the obtained perforated plate-shaped material, FIG. 14 shows a photograph of a part thereof, and FIG. 15 shows a photograph of a cross-section of the part. The through hole in the obtained perforated plate-shaped material had a largest width diameter of 222 μm in the first main surface portion and a smallest width diameter of 200 μm in the smallest width portion.

Referring to FIGS. 13 and 14, in the obtained perforated plate-shaped material, the embossed projections and recesses formed in the non-hole surface on the first main surface were also observed on the hole surface. Namely, at least a part of the first projecting curve portion on the hole surface had the surface property/shape of the non-hole surface on the first main surface. Substantially no burr was observed.

Referring to FIG. 15, in the cross-section of the part of the through hole in the perforated plate-shaped material, the hole surface forming the through hole had the second cross-sectional shape including the first projecting curve portion in the portion extending from the first main surface portion on the first main surface to the smallest width portion of the through hole and further including the straight portion in the portion extending from the smallest width portion of the through hole to the second main surface portion on the second main surface. Here, the first line segment length was 60% of the thickness of the perforated plate-shaped material. The third line segment length was 100% of the thickness of the perforated plate-shaped material.

### Example 4

The perforated plate-shaped material was obtained as in Example 1 except for use as the plate-shaped material, of a copper foil for collector having a thickness of 15 and having embossed projections and recesses formed in the first main surface through an electrolytic method.

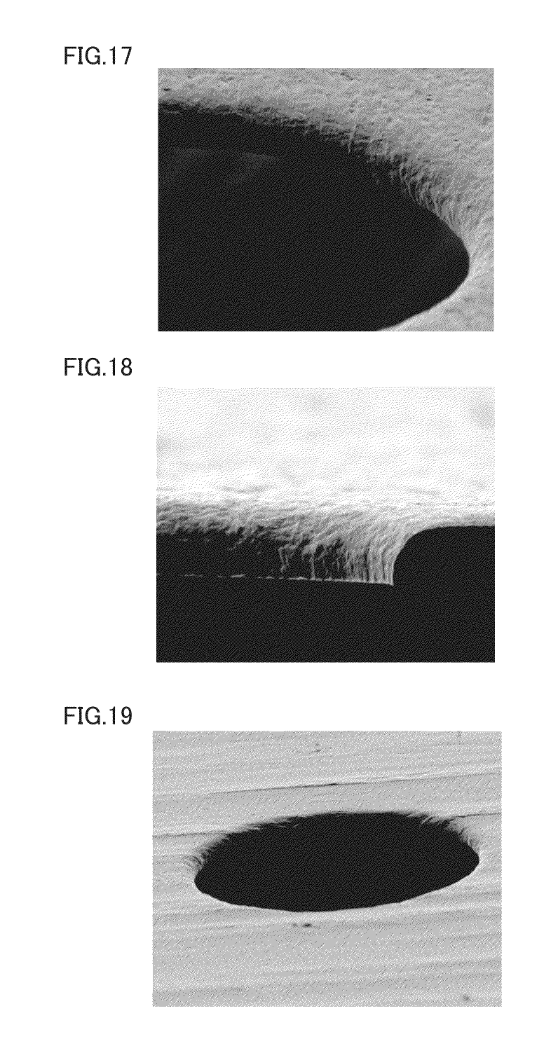

FIG. 16 shows a photograph of a full view of a through hole in the obtained perforated plate-shaped material, FIG. 17 shows a photograph of a part thereof, and FIG. 18 shows a photograph of a cross-section of the part. The through hole in the obtained perforated plate-shaped material had a largest width diameter of 231 μm in the first main surface portion and a smallest width diameter of 199 μm in the smallest width portion.

Referring to FIGS. 16 and 17, in the obtained perforated plate-shaped material, the embossed projections and recesses formed in the non-hole surface on the first main surface were also observed on the hole surface. Namely, at least a part of the first projecting curve portion on the hole surface had the surface property/shape of the non-hole surface on the first main surface. Substantially no burr was observed.

Referring to FIG. 18, in the cross-section of another part of the through hole in the perforated plate-shaped material, the hole surface forming the through hole had the first cross-sectional shape including only the first projecting curve portion in the portion extending from the first main surface portion on the first main surface to the smallest width portion of the through hole. Here, the first line segment length was 100% of the thickness of the perforated plate-shaped material. The third line segment length was 64% of the thickness of the perforated plate-shaped material.

### Example 5

The perforated plate-shaped material was obtained as in Example 1 except for use as the plate-shaped material, of a stainless steel foil having a thickness of 10 μm and having striped projections and recesses formed in the first main surface through a rolling method.

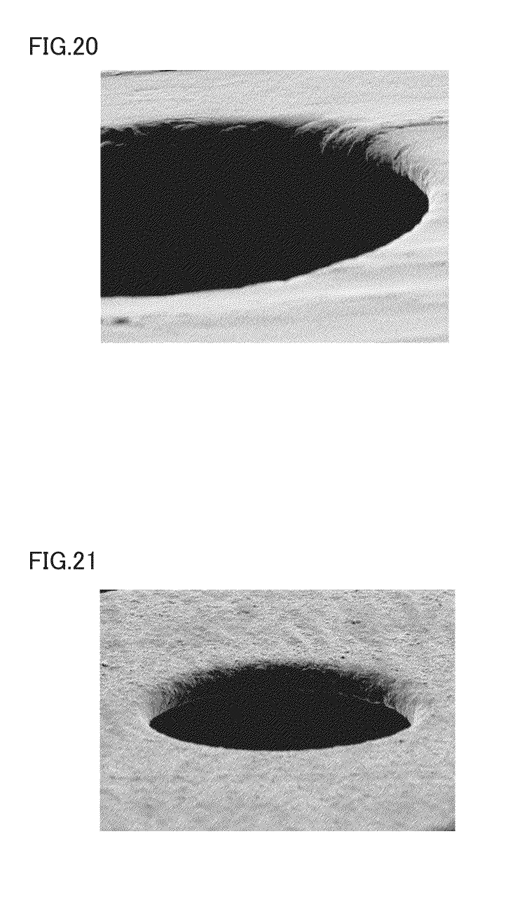

FIG. 19 shows a photograph of a full view of a through hole in the obtained perforated plate-shaped material and FIG. 20 shows a photograph of a part thereof. The through hole in the obtained perforated plate-shaped material had a largest width diameter of 215 μm in the first main surface portion and a smallest width diameter of 198 μm in the smallest width portion.

Referring to FIGS. 19 and 20, in the obtained perforated plate-shaped material, the striped projections and recesses formed in the non-hole surface on the first main surface were also observed on the hole surface. Namely, at least a part of the first projecting curve portion on the hole surface had the surface property/shape of the non-hole surface on the first main surface. Substantially no burr was observed.

### Example 6

The perforated plate-shaped material was obtained as in Example 1 except for use as the plate-shaped material, of a carbon-coated aluminum foil for collector (SDX-PM manufactured by Showa Denko Packaging K. K.) having a thickness of 21 μm, which had a first main surface coated with a carbon coat and had conductivity and projections and recesses provided to the surface.

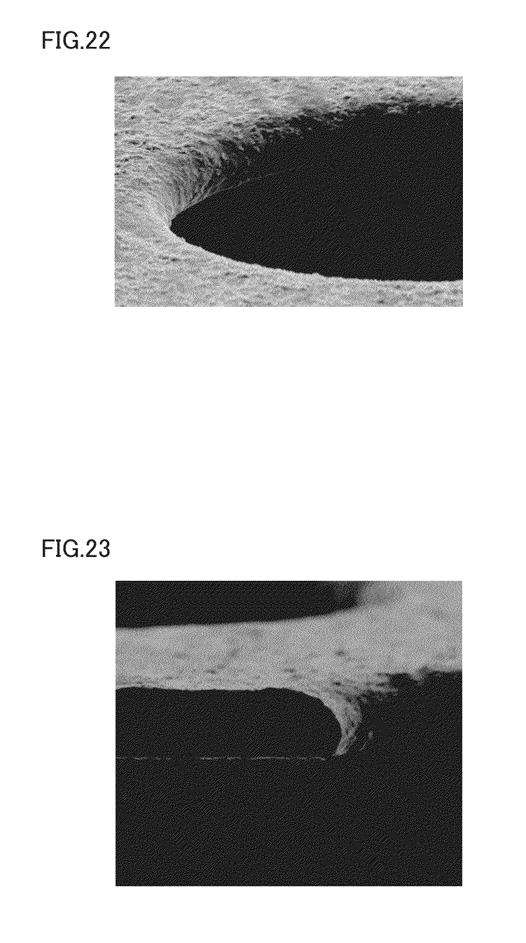

FIG. 21 shows a photograph of a full view of a through hole in the obtained perforated plate-shaped material, FIG. 22 shows a photograph of a part thereof, and FIG. 23 shows a photograph of a cross-section of the part. The through hole in the obtained perforated plate-shaped material had a largest width diameter of 213 μm in the first main surface portion and a smallest width diameter of 197 μm in the smallest width portion.

Referring to FIGS. 21 and 22, in the obtained perforated plate-shaped material, the projections and recesses formed in the non-hole surface on the first main surface were also observed on the hole surface. Namely, at least a part of the first projecting curve portion on the hole surface had the surface property/shape of the non-hole surface on the first main surface. Substantially no burr was observed.

Referring to FIG. 23, in the cross-section of the part of the through hole in the perforated plate-shaped material, the hole surface forming the through hole had the third cross-sectional shape including the first projecting curve portion in the portion extending from the first main surface portion to the smallest width portion of the through hole and further including the second projecting curve portion in the portion extending from the smallest width portion of the through hole to the second main surface portion. Here, the first line segment length was 63% of the thickness of the perforated plate-shaped material. The second line segment length was 37% of the thickness of the perforated plate-shaped material. The third line segment length was 83% of the thickness of the perforated plate-shaped material.

### Comparative Example 1

A copper foil for collector having a thickness of 15 μm and having embossed projections and recesses formed on a first main surface through an electrolytic method was arranged as the plate-shaped material on a die which was made of stainless steel and had a hole having a diameter of 302 μm, such that a side of a second main surface was in contact with the die. A punch having a diameter of 300 μm was arranged on the first main surface of plate-shaped material 1 which was the main surface opposite to the second main surface, and a perforated plate-shaped material was obtained with punching.

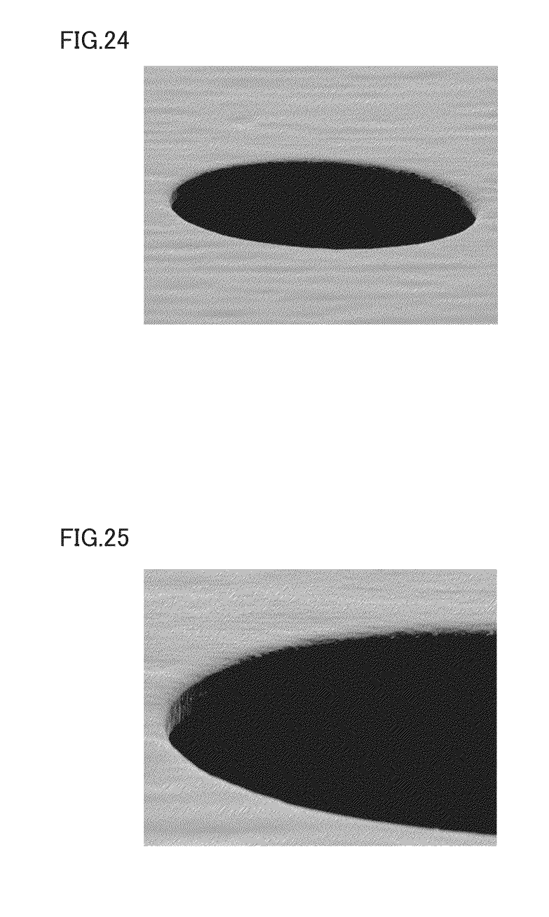

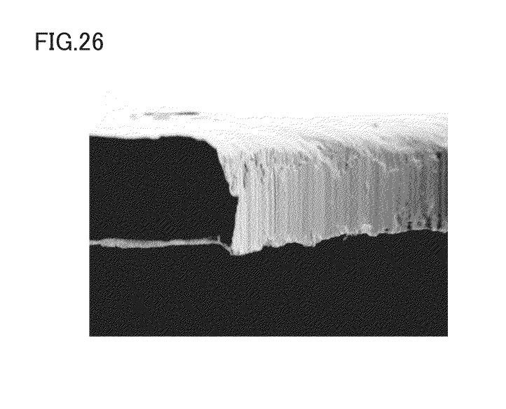

FIG. 24 shows a photograph of a full view of a through hole in the obtained perforated plate-shaped material, FIG. 25 shows a photograph of a part thereof, and FIG. 26 shows a photograph of a cross-section of the part. The through hole in the obtained perforated plate-shaped material had a largest width diameter of 311 μm in the first main surface portion and a smallest width diameter of 300 μm in the smallest width portion.

Referring to FIGS. 24 to 26, droop specific to punching was observed on the hole surface of the through hole in the perforated plate-shaped material, and embossed projections and recesses formed on the non-hole surface on the first main surface were not observed on a shear surface and a cut-away surface which occupied a major portion of the hole surface. A ratio of a height difference in a direction perpendicular to the first main surface, of the droop reaching the smallest width portion from the first main surface portion on the first main surface to the thickness of the plate-shaped material was 18%.

It should be understood that the embodiments and the examples disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 plate-shaped material; 10 perforated plate-shaped material; 10w through hole; 10wf perpendicularly projected image; 11 first main surface; 11m, 11n, 12m, 12n non-hole surface; 12 second main surface; 13 hole surface; 13cam, 13can first projecting curve portion; 13cbm, 13cbn second projecting curve portion; 13sm, 13sn straight portion; 111 die; 111e edge; 111r circumference; 111w hole; 113 die holder; 131 first solid object; 137 pressurization press; 151 first auxiliary solid object; 152 second auxiliary solid object; 151r, 152r axis of rotation; L1m, L1n first line segment length; L2m, L2n second line segment length; N₁₁ₘ, N₁₁ₙ normal; P₁₁ₘ, P₁₁ₙ first main surface portion; P₁₂ₘ, P₁₂ₙ second main surface portion; P_{F12m}, P_{F12n}, P_{FSm}, P_{FSn} foot of perpendicular line; Pₘ, Pₙ end portion of smallest width; P_{Sm}, P_{Sn} smallest width portion; P_{N12m}, P_{N12n} point where normal reaches second main surface; T thickness; W_{L} largest width; and W_{S} smallest width.

1. A perforated plate-shaped material having at least one through hole penetrating from a first main surface to a second main surface which is a main surface opposite to the first main surface, comprising, in a cross-sectional shape of the through hole in a plane perpendicularly intersecting, at a certain point on a contour of a perpendicularly projected image of the through hole onto the first main surface, with a tangent of the contour at the point:
a smallest width portion on a hole surface providing an end portion of a smallest width representing a width of the perpendicularly projected image of the through hole onto the first main surface and a first main surface portion where the hole surface of the through hole terminates on the first main surface; and
a first projecting curve portion in a portion extending from the first main surface portion to the smallest width portion,
at least a part of the first projecting curve portion having a surface property/shape of a non-hole surface other than the hole surface on the first main surface.

2. The perforated plate-shaped material according to claim 1, further comprising, in the cross-sectional shape of the through hole:
a second main surface portion where the hole surface of the through hole terminates on the second main surface; and
a second projecting curve portion in a portion extending from the smallest width portion to the second main surface portion.

3. The perforated plate-shaped material according to claim 1, wherein
in the cross-sectional shape of the through hole, with a normal passing through the first main surface portion and being perpendicular to the first main surface being drawn, a first line segment length from a foot of a perpendicular line from the smallest width portion to the normal to the first main surface portion is not less than 20% of a thickness of the perforated plate-shaped material.

4. The perforated plate-shaped material according to claim 2, wherein
in the cross-sectional shape of the through hole, with a normal passing through the first main surface portion and being perpendicular to the first main surface being drawn, a second line segment length from a foot of a perpendicular line from the smallest width portion to the normal to a foot of a perpendicular line from the second main surface portion to the normal is not more than 80% of a thickness of the perforated plate-shaped material.

5. The perforated plate-shaped material according to claim 1, wherein
in the cross-sectional shape of the through hole, with a normal passing through the first main surface portion and being perpendicular to the first main surface being drawn, a third line segment length representing a length of a perpendicular line from the smallest width portion to the normal is not less than 10% and not more than 500% of a thickness of the perforated plate-shaped material.

6. The perforated plate-shaped material according to claim 1, having at least a surface formed of a conductor and having a thickness not greater than 3 mm.

7. The perforated plate-shaped material according to claim 1, wherein
a diameter of a circle having an area equal to a hole area representing an area of the perpendicularly projected image of the through hole onto the first main surface is not greater than 2 mm.

8. The perforated plate-shaped material according to claim 1, wherein
in the perforated plate-shaped material, a height of a protruding object formed on at least any of the first main surface and the second main surface is not more than 50% of a thickness of the perforated plate-shaped material and the perforated plate-shaped material is a collector included in a power storage device.

9. A method of manufacturing the perforated plate-shaped material according to claim 1, comprising forming the through hole in a plate-shaped material by arranging the plate-shaped material on a die having a hole and an edge forming a circumference of the hole, applying a pressure to a region greater in size than the hole in the die in the plate-shaped material from at least one of a side of the plate-shaped material and a side of the die, and cutting the plate-shaped material at the edge of the die.
